(19) United States
(12) Patent Application Publication
(10) Pub. No.: US 2018/0010444 A1
(43) Pub. Date: Jan. 11, 2018

(54) DOWNHOLE FLUID FLOW DIRECTION SENSOR

(71) Applicant: HALLIBURTON ENERGY SERVICES, INC., Houston, TX (US)

(72) Inventors: Tu Dinh Nguyen, Plano, TX (US); Darrin Nathaniel Towers, Shady Shores, TX (US)

(21) Appl. No.: 15/540,000

(22) PCT Filed: Mar. 16, 2015
(86) PCT No.: PCT/US2015/020779

§ 371 Date: Jun. 26, 2017

(51) Int. Cl. E21B 47/10; G01P 13/02; E21B 47/12

(52) U.S. Cl. CPC E21B 47/102; E21B 47/122; G01P 13/02

(57) ABSTRACT

A system for use in a wellbore can include a component that is positioned in a flow path through a tubular for fluid. The component can be movable by the fluid between a first position and a second position for changing a magnitude of a magnetic field that is detectable by a sensor or inducing a current in the sensor. The system can also include the sensor positioned external to the tubular for determining a direction of a flow of the fluid through the tubular based on the magnitude of the magnetic field or a polarity of the current.

### TECHNICAL FIELD

The present disclosure relates generally to devices for use in well systems. More specifically, but not by way of limitation, this disclosure relates to a downhole fluid flow direction sensor.

### BACKGROUND

A well system (e.g., an oil or gas well for extracting fluid or gas from a subterranean formation) can include a wellbore drilled into a seafloor. A subsea tree can be positioned on the seafloor at a wellhead of the wellbore. The subsea tree can include ports, valves, and flow lines for controlling fluid flow through the well system. It can be challenging to determine a direction of the fluid flow.

### BRIEF DESCRIPTION OF THE DRAWINGS

FIG. 1 is a cross-sectional view of an example of a well system for detecting a fluid flow direction downhole according to some aspects.

FIG. 2 is a cross-sectional view of another example of a well system for detecting a fluid flow direction downhole according to some aspects.

FIG. 3 is a cross-sectional view of an example of a part of a well system for detecting a fluid flow direction downhole according to some aspects.

FIG. 4 is a cross-sectional view of an example of a fluid flow direction sensor according to some aspects.

FIG. 5 is a cross-sectional view of another example of a fluid flow direction sensor according to some aspects.

FIG. 6 is a block diagram of an example of a fluid flow direction sensor according to some aspects.

### DETAILED DESCRIPTION

Certain aspects and features of the present disclosure relate to a downhole fluid flow direction sensor. The downhole fluid flow direction sensor can include a component (e.g., a flapper) that is positioned in a flow path through a tubular for fluid. Fluid (e.g., liquid or gas) flowing through the tubular can move the component between two positions. For example, fluid flowing through the tubular in one direction can move the component from a first position to a second position. Fluid flowing through the tubular in the opposite direction can move the component from the second position to the first position. In some examples, the movement of the component between the positions can change a magnitude of a magnetic field that is detectable by a sensor (e.g., a Hall effect sensor). In other examples, the movement of the component between the positions can induce a current in the sensor (e.g., a wire coil). The downhole fluid flow direction sensor can determine a direction of the flow of the fluid through the tubular based on the magnitude of the magnetic field detected by the sensor or a characteristic of the current induced in the sensor.

In one example, the component can include a conductive material or a magnetic material. The sensor can include a coil positioned coaxially around the tubular. Fluid can push the component in the direction of the fluid flow through the tubular. In some examples, if the component is pushed in one direction, the movement of the component can induce a positive current in the coil. If the component is pushed in the opposite direction, the movement of the component can induce a negative current in the coil. The downhole fluid flow direction sensor can detect the polarity of the current and determine, based on the polarity, the direction of the fluid flowing through the tubular. In some examples, the downhole fluid flow direction sensor can transmit the direction of the fluid flowing through the tubular to a remote device via a wired or wireless interface.

In some examples, the fluid flow direction sensor may not penetrate through the tubular (e.g., which can be pressurized). For example, the fluid flow direction sensor can detect magnetic forces through the tubular and determine the direction of the fluid flow based on the magnetic forces, without penetrating the housing of the tubular. This can prevent the tubular from cracking, collapsing, rupturing, or otherwise deforming structurally due to the downhole environment (e.g., downhole pressures). This can also prevent fluid leakage through the tubular. In some examples, the fluid flow direction sensor can be temperature independent and require little calibration.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

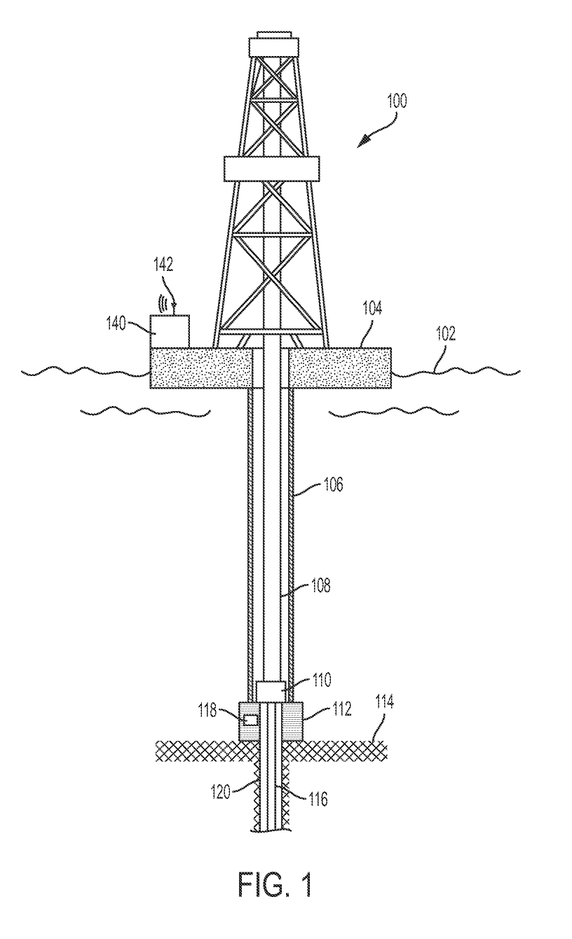

FIG. 1 is a cross-sectional view of an example of a well system 100 for detecting a fluid flow direction downhole according to some aspects. The well system 100 includes a platform 104. In some examples, the platform 104 can be a floating rig or a vessel positioned at the sea surface 102. A riser 106 can extend from the platform 104 to a subsea tree 112. The subsea tree 112 can be positioned at the sea floor 114. The riser 106 can include a tubular 108 (e.g., a landing string). The tubular 108 can extend from the platform 104 to the subsea tree 112. In some examples, a well operator can use the tubular 108 to communicate fluid, power, well tools, and other well components between the sea surface 102 and the sea floor 114.

The subsea tree 112 can include ports, valves, and flow lines for controlling fluid flow through the well system 100. In some examples, the subsea tree 112 can control the flow of fluid through a tubular 116 positioned in a wellbore 120 (e.g., below the sea floor 114). The tubular 116 can be positioned in the wellbore 120 for extracting hydrocarbons from the wellbore 120. In other examples, the subsea tree 112 can control the flow of fluid from the tubular 116 to other well tools in the well system 100. For example, the subsea tree 112 can control the flow of fluid from the tubular 116 to other well tools positioned on the sea floor 114. In some examples, the subsea tree 112 can include or otherwise be coupled to a subsea control system 110 for controlling the subsea tree 112.

The subsea tree 112 can include a fluid flow direction sensor 118. The fluid flow direction sensor 118 can be positioned within a fluid line (e.g., a tubular) for detecting a direction of a flow of a fluid (e.g., a liquid or gas) through the fluid line. In some examples, the fluid flow direction sensor 118 can transmit, via a wired or wireless communications interface, data associated with the direction of the fluid flow to the sea surface 102 (e.g., to a well operator at the sea surface 102). For example, the fluid flow direction sensor 118 can transmit a wireless signal to a computing device 140. In some examples, the computing device 140 can be positioned on the platform 104 or elsewhere at the sea surface 102.

The computing device 140 can include a processor interfaced with other hardware via a bus. A memory, which can include any suitable tangible (and non-transitory) computer-readable medium, such as RAM, ROM, EEPROM, or the like, can embody program components that configure operation of the computing device 140. In some aspects, the computing device 140 can include input/output interface components (e.g., a display, keyboard, touch-sensitive surface, and mouse) and additional storage.

The computing device 140 can include a communication device 142. The communication device 142 can represent one or more of any components that facilitate a network connection. In the example shown in FIG. 1, the communication device 142 is wireless and can include wireless interfaces such as IEEE 802.11, Bluetooth, or radio interfaces for accessing cellular telephone networks (e.g., transceiver/antenna for accessing a CDMA, GSM, UMTS, or other mobile communications network). In some examples, the communication device 142 can use acoustic waves, mud pulses, surface waves, vibrations, optical waves, or induction (e.g., magnetic induction) for engaging in wireless communications. In other examples, the communication device 142 can be wired and can include interfaces such as Ethernet, USB, IEEE 1394, or a fiber optic interface. The computing device 140 can receive wired or wireless communications from the fluid flow direction sensor 118 via the communication device 142 and perform one or more tasks based on the communications.

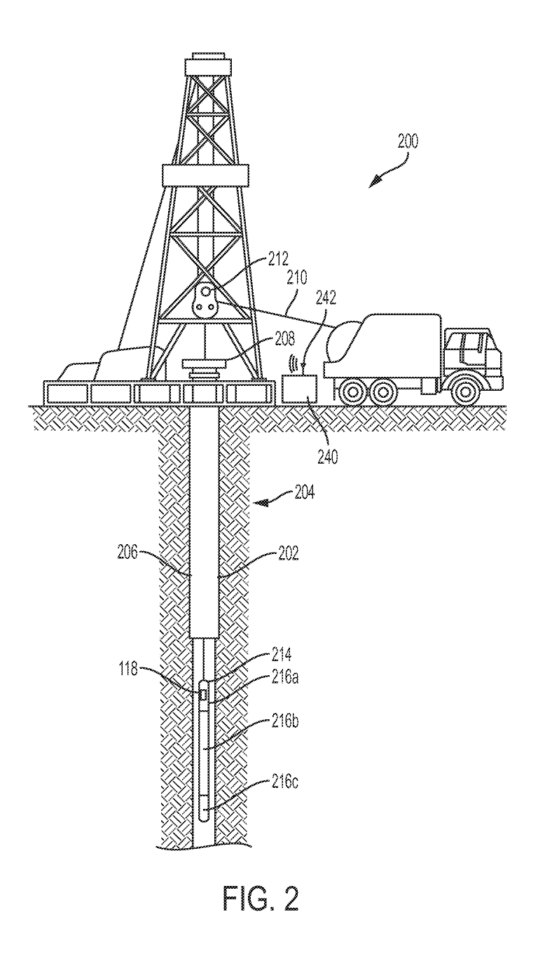

FIG. 2 is a cross-sectional view of an example of another well system 200 for detecting a fluid flow direction downhole according to some aspects. The well system 200 includes a wellbore 202 extending through various earth strata. The wellbore 202 extends through a hydrocarbon bearing subterranean formation 204. A casing string 206 extends from the well surface 208 to the subterranean formation 204. The casing string 206 can provide a conduit through which formation fluids, such as production fluids produced from the subterranean formation 204, can travel from the wellbore 202 to the well surface 208. The casing string 206 can be coupled to the walls of the wellbore 202 via cement. For example, a cement sheath can be positioned or formed between the casing string 206 and the walls of the wellbore 202 for coupling the casing string 206 to the wellbore 202.

The well system 200 can also include at least one well tool 214 (e.g., a formation-testing tool). The well tool 214 can be coupled to a wireline 210, slickline, or coiled tube that can be deployed into the wellbore 202. The wireline 210, slickline, or coiled tube can be guided into the wellbore 202 using, for example, a guide 212 or winch. In some examples, the wireline 210, slickline, or coiled tube can be wound around a reel 216.

The well tool 214 can include one or more modules 216a-c. For example, the well tool 214 can include a pump-out module 216a for pumping fluids out of the subterranean formation 204 and into the wellbore 202. The pump-out module 216a can include a pump and a series of valves for controlling the flow of fluids through the pump.

The well tool 214 (e.g., pump-out module 216a) can include a fluid flow direction sensor 118. The fluid flow direction sensor 118 can be positioned within a fluid line for detecting a direction of a fluid flow through the fluid line. In some examples, the fluid flow direction sensor 118 can transmit, via a wired or wireless communications interface, data associated with the direction of the fluid flow to a computing device 240.

The well system 200 can include a computing device 240. The computing device 240 can be positioned at the well surface 208, below ground, or offsite. The computing device 240 can be configured substantially the same as the computing device 140 of FIG. 1. The computing device 240 can include a communication device 242 that can be configured substantially the same as the communication device 142 of FIG. 1. The computing device 240 can receive wired or wireless communications from the fluid flow direction sensor 118 and perform one or more tasks based on the communications.

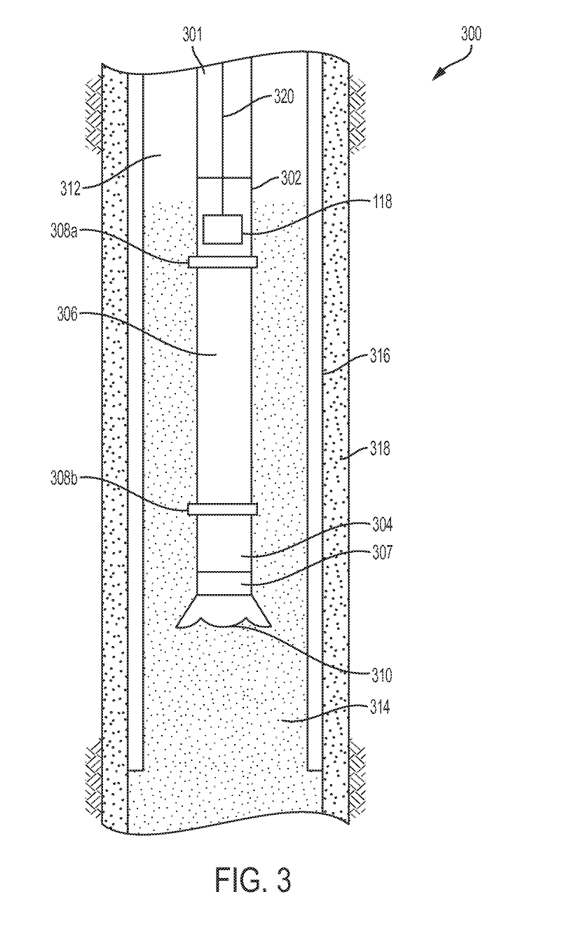

FIG. 3 is a cross-sectional side view of an example of a part of a well system 300 for detecting a fluid flow direction downhole according to some aspects. In this example, the well system 300 includes a wellbore. The wellbore can include a casing string 316 and a cement sheath 318. In some examples, the wellbore can include a fluid 314 (e.g., mud). The fluid 314 can flow in an annulus 312 positioned between the well tool 301 and a wall of the casing string 316.

A well tool 301 (e.g., logging-while-drilling tool) can be positioned in the wellbore. The well tool 301 can include various subsystems 302, 304, 306, 307. For example, the well tool 301 can include a subsystem 302 that includes a communication subsystem. The well tool 301 can also include a subsystem 304 that includes a saver subsystem or a rotary steerable system. A tubular section or an intermediate subsystem 306 (e.g., a mud motor or measuring-while-drilling module) can be positioned between the other subsystems 302, 304. In some examples, the well tool 301 can include a drill bit 310 for drilling the wellbore. The drill bit 310 can be coupled to another tubular section or intermediate subsystem 307 (e.g., a measuring-while-drilling module or a rotary steerable system). In some examples, the well tool 301 can also include tubular joints 308a, 308b.

The well tool 301 can include a fluid flow direction sensor 118. The fluid flow direction sensor 118 can be positioned within a fluid line for detecting a direction of a fluid flow through the fluid line. In some examples, the fluid flow direction sensor 118 can transmit, via a wired or wireless communications interface, data associated with the direction of the fluid flow to a computing device. In the example shown in FIG. 3, the fluid flow direction sensor 118 is coupled to a wire 320 for transmitting fluid flow data to the computing device.

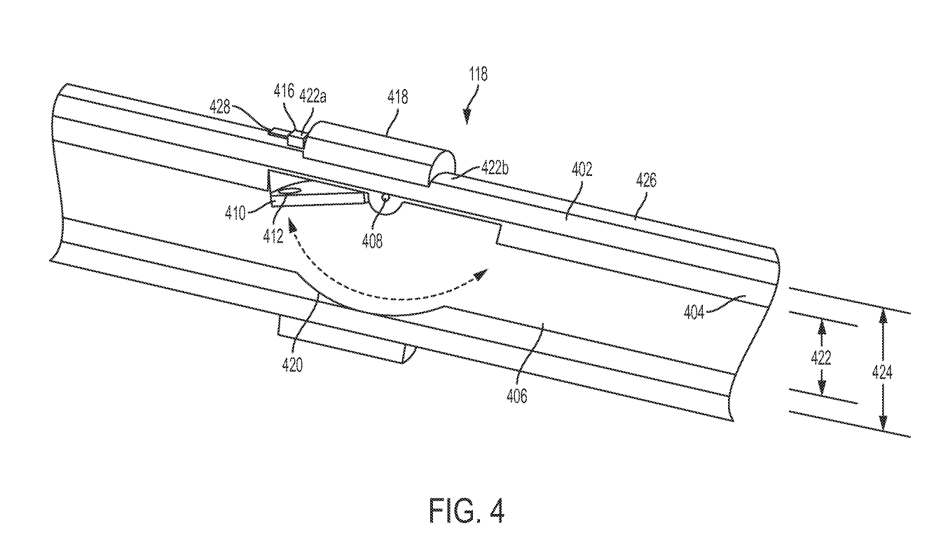

FIG. 4 is a cross-sectional view of an example of a fluid flow direction sensor 118 according to some aspects. The fluid flow direction sensor 118 can include an outer tubular 402. The outer tubular 402 can include a hollow interior for allowing fluid (e.g., a liquid or gas) to flow through the outer tubular 402. The outer tubular 402 can include any suitable non-magnetic material, such as stainless steel, rubber, or plastic. In some examples, the non-magnetic material can include a material that can withstand the downhole environment, such as downhole pressures and temperatures.

In some examples, an inner tubular 404 can be positioned within an inner diameter 424 of the outer tubular 402. The inner tubular 404 can extend a portion of a longitudinal length of the outer tubular 402. The inner tubular 404 can have an outer diameter that is smaller than an inner diameter 424 of the outer tubular 402. An inner diameter 422 of the inner tubular 404 can be hollow for allowing fluid to flow through the inner tubular 404. The inner tubular 404 can include any suitable non-magnetic material, such as stainless steel, rubber, or plastic.

A pivotable device 408 can be coupled to the inner tubular 404. For example, the pivotable device 408 can be positioned within the inner diameter 422 of the inner tubular 404. The pivotable device 408 can include any mechanism configured to pivot around an axis, such as a hinge or a ball-and-socket joint. A movable component 410 (e.g., a flapper) can be mechanically coupled to the pivotable device 408 for rotating around the axis (e.g., pivoting around the axis). As shown by the dashed lines, the movable component 410 can pivot about the pivotable device 408 within the inner diameter 422 of the inner tubular 404. In some examples, the inner tubular 404 can include a concave cutaway 420. This can allow the movable component 410 to pivot within the inner tubular 404, without being impeded by an inner surface of the inner tubular 404. Fluid flowing through the outer tubular 402 can push the movable component 410, causing the movable component 410 to pivot in one direction or another direction based on the direction of the fluid.

The movable component 410 can include a material 412. The material can be magnetic or a conductive. In one example, the material can include a magnetic material for generating a magnetic field. A sensor 416 (e.g., a Hall effect sensor) positioned external to the outer tubular 402 (and the inner tubular 404) can detect the magnetic field. In some examples, the fluid flow direction sensor 118 can determine that a fluid is flowing in a direction through the outer tubular 402 based on a property of the magnetic field. For instance, the fluid flow direction sensor 118 can determine that a fluid is flowing in one direction if the strength of the magnetic field is large. The fluid flow direction sensor 118 can determine that the fluid is flowing in the opposite direction if the sensor 416 based on the property of the magnetic field. For example, the fluid flow direction sensor 118 can determine that the fluid is flowing in the opposite direction if the sensor 416 does not detect a magnetic field or detects a small magnetic field. In some examples, the fluid flow direction sensor 118 can include multiple sensors 416. For example, sensors 416 can be positioned external to the outer tubular 402 and in locations 422a-b. The fluid flow direction sensor 118 can determine that the fluid is flowing in one direction if a sensor 416 in one location (e.g., location 422a) detects a large magnetic field, or that the fluid is flowing in the opposite direction if another sensor 416 in another location (e.g., location 422b) detect a large magnetic field.

Additionally or alternatively to the sensor 416, the fluid flow direction sensor 118 can include a coil 418. The coil 418 can include multiple wire windings. The coil 418 can be positioned coaxially around the outer tubular 402. In some examples, the coil 418 can traverse the entire circumference of the outer tubular 402. In other examples, the coil 418 may not traverse the entire circumference of the outer tubular 402. In some examples, fluid flowing through the outer tubular 402 can push the movable component 410, causing the (magnetic or conductive) material 412 coupled to the movable component 410 to move. The movement of the material 412 can induce current in the coil 418. For example, the material 412 can include a magnetic material. As the movable component 410 moves in one direction responsive to fluid pushing the movable component 410 in the direction, a positive current can be induced in the coil 418. As the movable component 410 moves in the opposite direction responsive to the fluid pushing the movable component in the opposite direction, a negative current can be induced in the coil 418. The fluid flow direction sensor 118 can measure the induced current and determine the direction of the fluid flow.

In some examples, the outer tubular 402 can be separate from the inner tubular 404. The inner tubular 404 can be inserted within the outer tubular 402, for example during installation or manufacturing, which can simplify the manufacturing process. In other examples, the fluid flow direction sensor 118 may not include the inner tubular 404. Rather, the pivotable device 408 can be directly coupled to the inner diameter of the outer tubular 402. The outer tubular 402 can include the concave cutaway 420 for allowing the movable component 410 to move within the inner diameter 424 of the outer tubular 402.

In some examples, the fluid flow direction sensor 118 can include additional circuitry 428. The additional circuitry 428 can include a power source, amplifier, current meter, voltage meter, resistor, capacitor, inductor, transistor, and other electrical components for operating the fluid flow direction sensor 118. In some examples, the additional circuitry 428 can include a wired or wireless interface for communicating data (e.g., about the direction of the fluid flowing through the outer tubular 402) to another device. The fluid flow direction sensor 118 can additionally or alternatively include a connector (e.g., pins) for connecting the fluid flow direction sensor 118 to another electrical component (e.g., a transceiver or external power source).

In some examples, the fluid flow direction sensor 118 may not penetrate through the outer tubular 402 (e.g., which can be pressurized). The outer tubular 402 can physically separate and isolate the movable component 410 (and the pivotable device 408) from the sensor 416, coil 418, or both. For example, the fluid flow direction sensor 118 can detect magnetic forces through the outer tubular 402 and determine the direction of the fluid flow based on the magnetic forces, without penetrating the housing 426 of the outer tubular 402. This can prevent the outer tubular 402 from cracking, collapsing, rupturing, or otherwise deforming structurally due to the downhole environment (e.g., downhole pressures). This can also prevent fluid leakage through the outer tubular 402. In some examples, the fluid flow direction sensor 118 can be temperature independent and require little calibration.

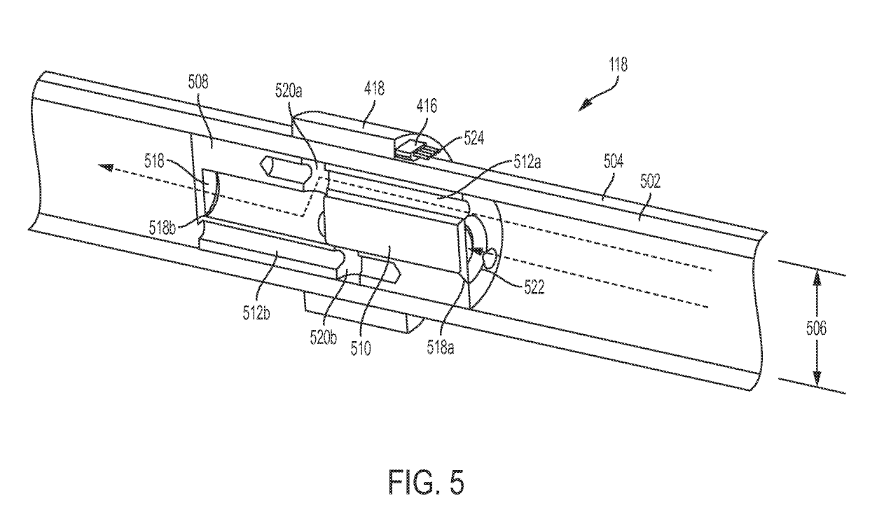

FIG. 5 is a cross-sectional view of an example of a fluid flow direction sensor 118 according to some aspects. The fluid flow direction sensor 118 can include an outer tubular 502 with an outer housing 504. The outer tubular 502 can be configured substantially the same as the outer tubular 402 of FIG. 4.

A module 508 can be positioned within an inner diameter 506 of the outer tubular 502. In some examples, the module 508 can be manufactured separately from and inserted into the outer tubular 502. The module 508 can be substantially cylindrical in shape and can include an outer diameter that is smaller than an inner diameter 506 of the outer tubular 502. This can allow the module 508 to fit snugly within the inner diameter 506 of the outer tubular 502. The module 508 can include a hollow interior for allowing a movable component 510 to move through the interior of the module 508.

The module 508 can include a moveable component 510. The movable component 510 can include a cylindrical or spherical shape. In some examples, the movable component 510 can include a magnetic or a conductive material. The movable component 510 can include an outer diameter that is smaller than an inner diameter of the module 508. Fluid flowing through the outer tubular 502 can push the movable component 510 through the module 508 from one positioned at one side 518a of the module 508 to another position at another side 518b of the module 508. For example, as depicted by the dashed lines, fluid can flow from the right side of the outer tubular 502 to the left side of the outer tubular 502. A portion of the fluid can flow through a bypass channel 512a into a chamber 520a, and from the chamber 520a out a port 518 in the module 508. The remainder of the fluid can push the movable component 510 from one side 518a of the module 508 to the other side 518a of the module 508. This can cause the movable component 510 to slide from one side 518a of the module 508 to the other side 518a of the module 508. In some examples, this can cutoff and prevent fluid from flowing through the bypass channel 512a and chamber 520a, while opening and allowing fluid to flow through port 522, bypass channel 512b, and chamber 520b. If the fluid flow direction is then reversed, the movable component 510 can move (e.g., slide) back to the position depicted in FIG. 5. This can cutoff and prevent fluid from flowing through the port 522, bypass channel 512b, and chamber 520b, while opening and allowing fluid to flow through port 518, bypass channel 512a, and chamber 520a.

A coil 418 can be positioned coaxially around the outer housing 504 of the outer tubular 502. Movement of the movable component 510 can induce current in the coil 418. The fluid flow direction sensor 118 can detect the current and, based on the current, determine a direction of a fluid flowing through the outer tubular 502. For example, the moveable component 510 can include a magnetic material. As fluid pushes the moveable component 510 from one position within the outer tubular 502 (e.g., one side 518b of the outer tubular 502) to another position within the outer tubular 502 (e.g., to another side 518a of the outer tubular 502), a positive current can be induced in the coil 418. As fluid pushes the movable component 510 in the opposite direction through the outer tubular 502, a negative current can be induced in the coil 418. The fluid flow direction sensor 118 can measure the induced current and determine the direction of the fluid flow.

Additionally or alternatively to the coil 418, the fluid flow direction sensor 118 can include a sensor 416 positioned external to the outer tubular 502. In some examples, the fluid flow direction sensor 118 can determine that a fluid is flowing in a direction through the outer tubular 502 based on the magnitude of a magnetic field detected by the sensor 416. For example, the fluid flow direction sensor 118 can determine that a fluid is flowing in one direction if the sensor 416 detects a large magnetic field, and that the fluid is flowing in another direction if the sensor 416 does not detect a magnetic field (or detects a small magnetic field). In some examples, the fluid flow direction sensor 118 can include multiple sensors 416 (e.g., as described with respect to FIG. 4).

In some examples, the fluid flow direction sensor 118 can include fewer components than those depicted in FIG. 5. In one example, the module 508 may not include the bypass channels 512a-b or the chambers 520a-b. In such an example, the movable component 510 can include a cylindrical shape with a hollow interior. Fluid can substantially simultaneously flow through the hollow interior of the movable component 510 and push the movable component 510 from one position within the module 508 to another position within the module 508. The fluid flow direction sensor 118 can detect the movement of the movable component 510 and determine the direction of the fluid flow.

In some examples, the fluid flow direction sensor 118 can include a connector (e.g., pins) for connecting the fluid flow direction sensor 118 to another electrical component (e.g., a transceiver or external power source). The fluid flow direction sensor 118 can additionally or alternatively include additional circuitry (e.g., the additional circuitry 424 described with respect to FIG. 4).

In some examples, the fluid flow direction sensor 118 may not penetrate through the outer tubular 502 (e.g., which can be pressurized). For example, the outer tubular 502 can physically separate and isolate the movable component 510 (and the module 508) from the sensor 416, coil 418, or both. This can prevent the outer tubular 502 from cracking, collapsing, rupturing, or otherwise deforming structurally due to the downhole environment (e.g., downhole pressures). This can also prevent fluid leakage through the outer tubular 502. In some examples, the fluid flow direction sensor 118 can be temperature independent and require little calibration.

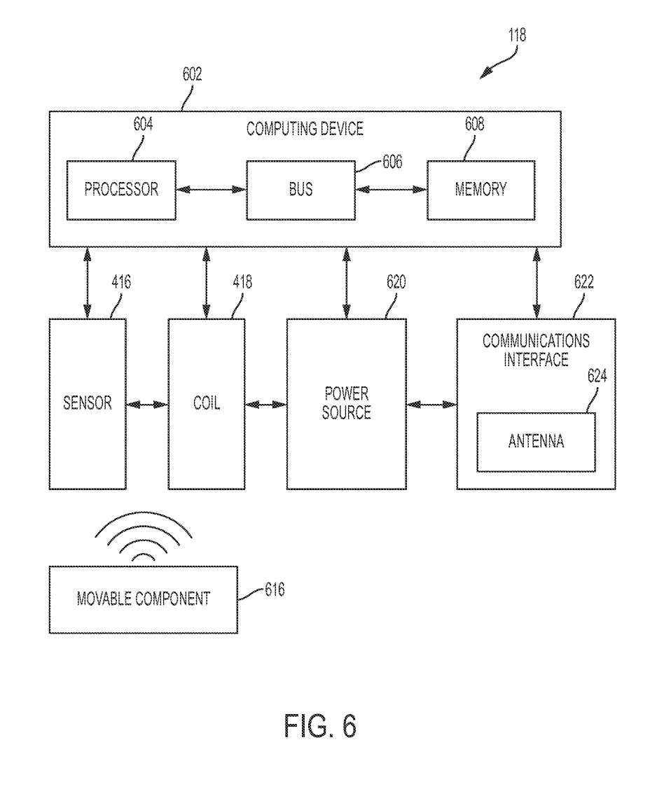

FIG. 6 is a block diagram of an example of a fluid flow direction sensor 118 according to some aspects. In some examples, the components shown in FIG. 6 (e.g., the computing device 602, power source 620, and communications interface 622) can be integrated into a single structure. For example, the components can be within a single housing. In other examples, the components shown in FIG. 6 can be distributed (e.g., in separate housings) and in electrical communication with each other.

The fluid flow direction sensor 118 can include a computing device 602. The computing device 602 can include a processor 604, a memory 608, and a bus 606. The processor 604 can execute one or more operations for operating a transceiver. The processor 604 can execute instructions stored in the memory 608 to perform the operations. The processor 604 can include one processing device or multiple processing devices. Non-limiting examples of the processor 604 include a Field-Programmable Gate Array (“FPGA”), an application-specific integrated circuit (“ASIC”), a microprocessor, etc.

The processor 604 can be communicatively coupled to the memory 608 via the bus 606. The non-volatile memory 608 may include any type of memory device that retains stored information when powered off. Non-limiting examples of the memory 608 include electrically erasable and programmable read-only memory (“EEPROM”), flash memory, or any other type of non-volatile memory. In some examples, at least some of the memory 608 can include a medium from which the processor 604 can read instructions. A computer-readable medium can include electronic, optical, magnetic, or other storage devices capable of providing the processor 604 with computer-readable instructions or other program code. Non-limiting examples of a computer-readable medium include (but are not limited to) magnetic disk(s), memory chip(s), ROM, random-access memory (“RAM”), an ASIC, a configured processor, optical storage, or any other medium from which a computer processor can read instructions. The instructions can include processor-specific instructions generated by a compiler or an interpreter from code written in any suitable computer-programming language, including, for example, C, C++, C#, etc.

The fluid flow direction sensor 118 can include a power source 620. The power source 620 can be in electrical communication with the computing device 602, the communications interface 622, and the sensor 416. In some examples, the power source 620 can include a battery (e.g. for powering the fluid flow direction sensor 118). In other examples, the fluid flow direction sensor 118 can be coupled to and powered by an electrical cable (e.g., a wireline).

Additionally or alternatively, the power source 620 can include an AC signal generator. The computing device 602 can operate the power source 620 to apply a transmission signal to the antenna 624. For example, the computing device 602 can cause the power source 620 to apply a voltage with a frequency within a specific frequency range to the antenna 624. This can cause the antenna 624 to generate a wireless transmission. In other examples, the computing device 602, rather than the power source 620, can apply the transmission signal to the antenna 624.

The fluid flow direction sensor 118 can include a communications interface 622. The communications interface 622 can include or can be coupled to an antenna 624. In some examples, part of the communications interface 622 can be implemented in software. For example, the communications interface 622 can include instructions stored in memory 608.

The communications interface 622 can receive signals from remote devices and transmit data (e.g., wirelessly via the antenna 624) to remote devices. For example, the communications interface 622 can transmit wireless communications that are modulated by data via the antenna 624. In some examples, the communications interface 622 can receive signals (e.g., associated with data to be transmitted) from the processor 604 and amplify, filter, modulate, frequency shift, and otherwise manipulate the signals. The communications interface 622 can transmit the manipulated signals to the antenna 624. The antenna 624 can receive the manipulated signals and responsively generate wireless communications that carry the data.

In some examples, the communications interface 622 can transmit data via a wired interface. For example, the communications interface 622 can transmit data via a wireline. As another example, the communications interface 622 can generate an optical waveform. The communications interface 622 may generate the optical waveform by pulsing a light emitting diode at a particular frequency. The communications interface 622 can transmit the optical waveform via an optical cable (e.g., a fiber optic cable).

The fluid flow direction sensor 118 can include a sensor 416 (e.g., a Hall effect sensor). The sensor 416 can detect movement of the movable component 616 and transmit an associated sensor signal to the processor 604. For example, the sensor 416 can detect a characteristic (e.g., an amplitude) of a magnetic field output by the movable component 616 and transmit a sensor signal associated with the characteristic to the processor 604. The processor 604 can determine, based on the characteristic, whether the moveable component 616 is in a first position or a second position. The processor 604 can further determine, based on whether the movable component 616 is in the first position or the second position, the direction of the fluid flowing through the tubular.

In some examples, the processor 604 can detect an amplitude of a sensor signal and determine a direction of a fluid based on the amplitude. For example, the sensor 416 can transmit a sensor signal with an amplitude indicative of a distance between the sensor 416 and the movable component 616 to the processor 604. The processor 604 can receive the sensor signal and determine, based on the sensor signal, whether the movable component 616 is in a particular position. For example, if the sensor signal has a large amplitude, the processor 604 can determine that the movable component 616 is near the sensor 416. This may indicate that the movable component 616 is in one position. If the sensor signal has a small amplitude, the processor 604 can determine that the movable component 616 is far from the sensor 416. This may indicate that the movable component 616 is in a different position.

In some examples, the fluid flow direction sensor 118 can include a coil 418. Movement of the movable component 616 can induce a current or voltage in the coil 418. The processor 604, or another electrical component (e.g., a voltmeter or current meter), can detect the current or voltage. Based on the current or voltage, the processor 604 (or other electrical component) can determine a position of the movable component 616. For example, as the movable component 616 moves from a first position to a second position, the movement can induce a positive current in the coil 418. The processor 604 can detect the positive current and determine that the movable component 616 is in the second position. If the movable component 616 moves from the second position to the first position, the movement can induce a negative current in the coil 418. The processor 604 can detect the negative current and determine that the movable component 616 is in the first position. The processor 604 can further determine, based on whether the movable component 616 is in the first position or the second position, the direction of the fluid flowing through the tubular.

In some aspects, a downhole fluid flow direction sensor is provided according to one or more of the following examples:

### Example #1

A system for use in a wellbore can include a component that is positioned in a flow path through a tubular for fluid. The component can be movable by the fluid between a first position and a second position for changing a magnitude of a magnetic field that is detectable by a sensor or for inducing a current in the sensor. The system can also include the sensor positioned external to the tubular for determining a direction of a flow of the fluid through the tubular based on the magnitude of the magnetic field or a polarity of the current.

### Example #2

The system of Example #1 may feature the sensor including a Hall effect sensor. The component can be movable between the first position and the second position for changing the magnitude of the magnetic field that is detectable by the sensor.

### Example #3

The system of any of Examples #1-2 may feature the sensor including a coil positioned coaxially around an outer housing of the tubular. The component can be movable between the first position and the second position for inducing the current in the coil.

### Example #4

The system of any of Examples #1-3 may feature the component being coupled to a pivotable device for pivoting between the first position and the second position.

### Example #5

The system of any of Examples #1-4 may feature a pivotable device being coupled to an inner tubular positioned within the tubular.

### Example #6

The system of any of Examples #1-5 may feature an inner tubular including a concave cutaway for allowing the component to pivot between the first position and the second position.

### Example #7

The system of any of Examples #1-3 and 5 may feature the component including a cylindrical shape and being movable through a module that comprises a hollow interior. The module can be positionable within the tubular.

### Example #8

The system of any of Examples #1-7 may feature a module that includes a first bypass channel coupled to a first chamber. The first bypass channel and the first chamber operable can allow the fluid to flow through the module when the component is in the first position. The component can block the flow of the fluid through a second bypass channel and a second chamber when the component is in the first position.

### Example #9

The system of Example #8 may feature the module including the second bypass channel coupled to the second chamber. The second bypass channel and the second chamber can be operable to allow the fluid to flow through the module when the component is in the second position. The component can block the flow of the fluid through the first bypass channel and the first chamber when the component is in the second position.

### Example #10

The system of any of Examples #1-9 may feature the sensor being in communication with a processing device and a memory device. The memory device can store instructions executable by the processing device for causing the processing device to: receive a sensor signal from the sensor; determine whether the component is in the first position or the second position based on the magnitude of the magnetic field or the polarity of the current indicated by the sensor signal; determine the fluid is flowing in one direction if the component is in the first position or that the fluid is flowing in another direction if the component is in the second position; and transmit a wireless signal representative of the direction of the flow of the fluid to a remote device.

### Example #11

The system of any of Examples #1-10 may feature the tubular. The tubular can physically isolate the component from the sensor.

### Example #12

An assembly for use in a wellbore can include a pivotable component that is positionable in a flow path through a tubular for fluid. The pivotable component can be pivotable by the fluid between (i) a first position at which a magnetic field generated by the pivotable component has a magnitude detectable by a sensor and (ii) a second position at which the magnetic field generated by the pivotable component has another magnitude detectable by the sensor for determining a direction of the fluid through the tubular.

### Example #13

The assembly of Example #12 may feature the pivotable component being coupled to a pivoting device for pivoting between the first position and the second position.

### Example #14

The assembly of any of Examples #12-13 may feature the pivoting device being coupled to an inner tubular that is positionable within the tubular.

### Example #15

The assembly of any of Examples #12-14 may feature the inner tubular including a concave cutaway for allowing the pivotable component to pivot between the first position and the second position.

### Example #16

An assembly for use in a wellbore can include a slidable component positioned in a flow path through a tubular for fluid. The slidable component can be slidable by the fluid between a first position and a second position for inducing a current in a sensor positioned external to the tubular for determining a direction of the fluid through the tubular.

### Example #17

The assembly of Example #16 may feature the slidable component including a cylindrical shape and is slidable between the first position and the second position through a hollow interior of a module that is positionable in the tubular.

### Example #18

The assembly of any of Examples #16-17 may feature a module including a first bypass channel coupled to a first chamber. The first bypass channel and the first chamber operable can allow the fluid to flow through the module when the slidable component is in the first position. The slidable component can block the flow of the fluid through a second bypass channel and a second chamber when the slidable component is in the first position.

### Example #19

The assembly of Example #18 may feature the module including the second bypass channel coupled to the second chamber. The second bypass channel and the second chamber can be operable to allow the fluid to flow through the module when the slidable component is in the second position. The slidable component can block the flow of the fluid through the first bypass channel and the first chamber when the slidable component is in the second position.

### Example #20

The assembly of any of Examples #16-19 may feature the sensor including a coil positioned coaxially around an outer housing of the tubular and the slidable component being movable between the first position and the second position for inducing the current in the coil.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system for use in a wellbore, the system comprising:
a component that is positioned in a flow path through a tubular for fluid, the component being movable by the fluid between a first position and a second position for changing a magnitude of a magnetic field that is detectable by a sensor or for inducing a current in the sensor; and
the sensor positioned external to the tubular for determining a direction of a flow of the fluid through the tubular based on the magnitude of the magnetic field or a polarity of the current.

2. The system of claim 1, wherein the sensor comprises a Hall effect sensor and the component is movable between the first position and the second position for changing the magnitude of the magnetic field that is detectable by the sensor.

3. The system of claim 1, wherein the sensor comprises a coil positioned coaxially around an outer housing of the tubular and the component is movable between the first position and the second position for inducing the current in the coil.

4. The system of claim 1, wherein the component is coupled to a pivotable device for pivoting between the first position and the second position.

5. The system of claim 4, wherein the pivotable device is coupled to an inner tubular positioned within the tubular.

6. The system of claim 5, wherein the inner tubular comprises a concave cutaway for allowing the component to pivot between the first position and the second position.

7. The system of claim 1, wherein the component includes a cylindrical shape and is movable through a module that comprises a hollow interior, the module positionable within the tubular.

8. The system of claim 7, wherein the module comprises a first bypass channel coupled to a first chamber, the first bypass channel and the first chamber operable to allow the fluid to flow through the module when the component is in the first position, wherein the component blocks the flow of the fluid through a second bypass channel and a second chamber when the component is in the first position.

9. The system of claim 8, wherein the module comprises the second bypass channel coupled to the second chamber, the second bypass channel and the second chamber operable to allow the fluid to flow through the module when the component is in the second position, wherein the component blocks the flow of the fluid through the first bypass channel and the first chamber when the component is in the second position.

10. The system of claim 1, wherein the sensor is in communication with a processing device and a memory device in which instructions executable by the processing device are stored for causing the processing device to:
receive a sensor signal from the sensor;
determine whether the component is in the first position or the second position based on the magnitude of the magnetic field or the polarity of the current indicated by the sensor signal;
determine the fluid is flowing in one direction if the component is in the first position or that the fluid is flowing in another direction if the component is in the second position; and
transmit a wireless signal representative of the direction of the flow of the fluid to a remote device.

11. The system of claim 1, further comprising the tubular, wherein the tubular physically isolates the component from the sensor.

12. An assembly for use in a wellbore, the assembly comprising:
a pivotable component that is positionable in a flow path through a tubular for fluid, the pivotable component being pivotable by the fluid between (i) a first position at which a magnetic field generated by the pivotable component has a magnitude detectable by a sensor and (ii) a second position at which the magnetic field generated by the pivotable component has another magnitude detectable by the sensor for determining a direction of the fluid through the tubular.

13. The assembly of claim 12, wherein the pivotable component is coupled to a pivoting device for pivoting between the first position and the second position.

14. The assembly of claim 13, wherein the pivoting device is coupled to an inner tubular that is positionable within the tubular.

15. The assembly of claim 14, wherein the inner tubular comprises a concave cutaway for allowing the pivotable component to pivot between the first position and the second position.

16. An assembly for use in a wellbore, the assembly comprising:
a slidable component positioned in a flow path through a tubular for fluid, the slidable component being slidable by the fluid between a first position and a second position for inducing a current in a sensor positioned external to the tubular for determining a direction of the fluid through the tubular.

17. The assembly of claim 16, wherein the slidable component comprises a cylindrical shape and is slidable between the first position and the second position through a hollow interior of a module that is positionable in the tubular.

18. The assembly of claim 17, wherein the module comprises a first bypass channel coupled to a first chamber, the first bypass channel and the first chamber operable to allow the fluid to flow through the module when the slidable component is in the first position, wherein the slidable component blocks the flow of the fluid through a second bypass channel and a second chamber when the slidable component is in the first position.

19. The assembly of claim 18, wherein the module comprises the second bypass channel coupled to the second chamber, the second bypass channel and the second chamber operable to allow the fluid to flow through the module when the slidable component is in the second position, wherein the slidable component blocks the flow of the fluid through the first bypass channel and the first chamber when the slidable component is in the second position.

20. The assembly of claim 16, wherein the sensor comprises a coil positioned coaxially around an outer housing of the tubular and the slidable component is movable between the first position and the second position for inducing the current in the coil.
